(19) United States
(12) Patent Application Publication
(10) Pub. No.: US 2018/0257356 A1
(43) Pub. Date: Sep. 13, 2018

(54) SHEET

(71) Applicant: FUJI XEROX CO., LTD., Tokyo (JP)

(72) Inventors: Ryohei KIRIYAMA, Yokohama-shi (JP); Kojiro TSUTSUMI, Yokohama-shi (JP); Katsumi HARADA, Yokohama-shi (JP); Toshiyasu YUKAWA, Yokohama-shi (JP)

(73) Assignee: FUJI XEROX CO., LTD., Tokyo (JP)

(21) Appl. No.: 15/640,822

(22) Filed: Jul. 3, 2017

(30) Foreign Application Priority Data
Mar. 7, 2017 (JP) 2017-043176
Mar. 7, 2017 (JP) 2017-043177
Mar. 23, 2017 (JP) 2017-057999

(51) Int. Cl. B32B 29/00; B32B 7/12; B32B 3/30

(52) U.S. Cl. CPC B32B 29/002; B32B 3/30; B32B 7/12

(57) ABSTRACT

A sheet includes: a cut that is formed in a part, in a sheet thickness direction, of a bending portion, to be subjected to bending, of a sheet body; and a bonding layer that lies between a layer that is formed with the cut in the bending portion and a layer that is not with the cut in the bending portion, in a sectional view taken perpendicularly to the surfaces of the sheet.

### CROSS-REFERENCE TO RELATED APPLICATIONS

This application is based on and claims priority under 35 USC 119 from Japanese Patent Application No. 2017-043176 filed on Mar. 7, 2017, Japanese Patent Application No. 2017-043177 filed on Mar. 7, 2017 and Japanese Patent Application No. 2017-057999 filed on Mar. 23, 2017.

### BACKGROUND

### Technical Field

The present invention relates to a sheet.

### SUMMARY

According to an aspect of the invention, there is provided a sheet comprising a cut that is formed in a part, in a sheet thickness direction, of a bending portion, to be subjected to bending, of a sheet body; and a bonding layer that lies between a layer that is formed with the cut in the bending portion and a layer that is not with the cut in the bending portion in a sectional view taken perpendicularly to the surfaces of the sheet.

### BRIEF DESCRIPTION OF THE DRAWINGS

Exemplary embodiments of the present invention will be described in detail based on the following figures, wherein:

FIG. 1 shows a paper sheet according to an exemplary embodiment;

FIG. 2 is a sectional view of the paper sheet taken along line II-II in FIG. 1;

Each of a set of FIG. 3-1A, FIG. 3-1B and FIG. 3-1C and a set of FIG. 3-1D, FIG. 3-1E and FIG. 3-1F shows how a bending portion and its neighborhood of a paper sheet behave in a case that the bending portion is formed with a score;

FIG. 3-2A, FIG. 3-2B and FIG. 3-2C show how a common thick paper sheet formed with a score behaves when it is bent;

FIG. 4 shows a paper sheet having another example configuration;

FIGS. 5A and 5B show respective states of each bending portion as subjected to bending;

FIG. 6 shows a paper sheet having another example configuration;

Parts (A)-(D) of FIG. 7 illustrate a bending portion 300 having another example structure;

FIG. 8A and FIG. 8B illustrate a paper sheet having another example configuration;

FIG. 9 shows a paper sheet having still another example configuration;

FIG. 10A, FIG. 10B, FIG. 10C, FIG. 10D and FIG. 10E show paper sheets having other example configurations;

FIG. 11A and FIG. 11B illustrate a manufacturing process of a paper sheet;

FIG. 12A and FIG. 12B show a paper sheet having a further example configuration; and

FIG. 13 shows separating cuts having other structures.

### DESCRIPTION OF SYMBOLS

400 . . . Paper sheet body; 400A . . . Front-side sheet; 400B . . . Back-side sheet; 400C . . . Bonding layer (adhesive layer); 400S . . . Opening; 400T . . . Opening; 400X . . . Opening edge; 400Y . . . Opening edge; 410 . . . Bending cut; 420 . . . Separating cut; 420A . . . Front-side separating cut; 420B . . . Back-side separating cut; 470 . . . Non-cut portion; P . . . Paper sheet.

### DETAILED DESCRIPTION

An exemplary embodiment of the present invention will be hereinafter described in detail with reference to the accompanying drawings.

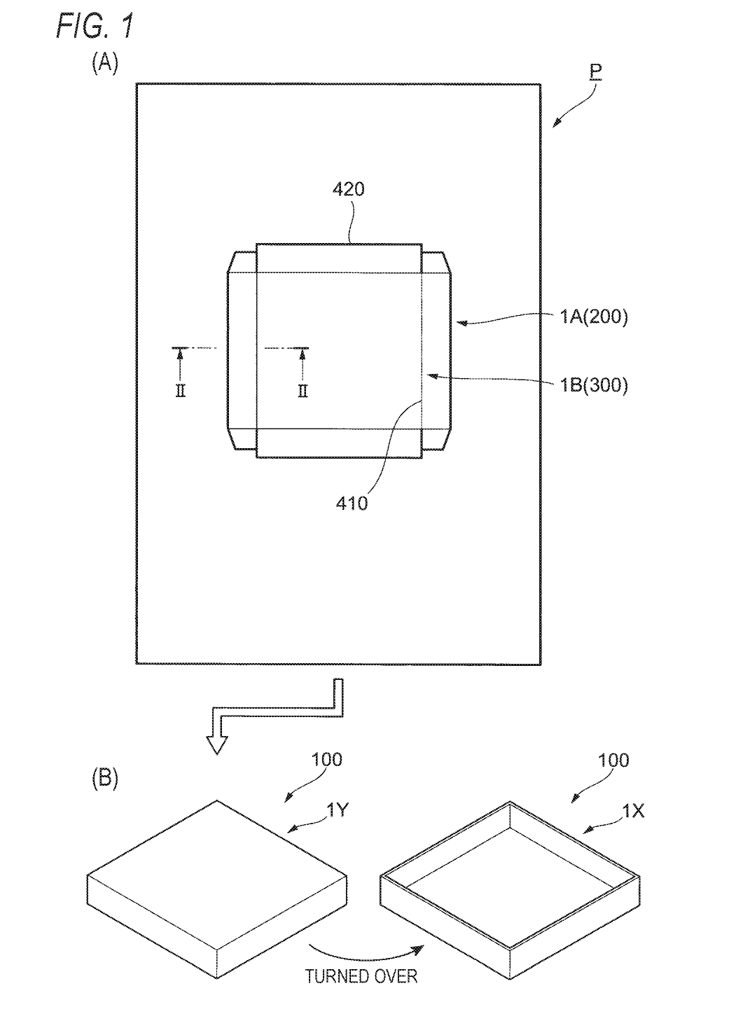

Parts (A) and (B) of FIG. 1 show a paper sheet P according to the exemplary embodiment. Part (A) of FIG. 1 is a front view of the paper sheet P, and part (B) of FIG. 1 is a perspective view of an object formed from the paper sheet P.

As shown in part (A) of FIG. 1, the paper sheet P according to the exemplary embodiment has a rectangular shape. The paper sheet P is to be subjected to dividing (cutting) and bending. First, by cutting the paper sheet P, a part (a part inside thick solid lines 1A in part (A) of FIG. 1) of the paper sheet P is separated from the other part. Then the separated part of the paper sheet P is subjected to bending.

Finally, a box-shaped object (three-dimensional object) 100 is formed that is in a state indicated by symbol 1X in part (B) of FIG. 1. More specifically, first, the object 100 is formed so as to be in a state indicated by symbol 1Y in part (B) of FIG. 1 by bending the separated part of the paper sheet P. Then the object 100 is rendered into the state 1X by turning over the object 100 being in the state 1Y.

In part (A) of FIG. 1, thick solid lines 1A indicate separating portions 200 where the paper sheet P is to be divided and thin solid lines 1B indicate bending portions 300 where the paper sheet P is to be bent. The separating portions 200 are formed with cuts (described later in detail), whereby the paper sheet P can be divided there by hands without using scissors or the like. The bending portions 300 are also formed with cuts, whereby the paper sheet P can be bent more easily than in a case that no such cuts are formed.

Although FIG. 1 shows an example case that the three-dimensional object 100 is formed from the paper sheet P, the object to be formed is not limited to a three-dimensional object.

A planar object to be used for a business card, a postcard, or the like can be formed by dividing the paper sheet P. To forming a planar object, bending portions 300 are not formed in the paper sheet P.

Furthermore, although the paper sheet P shown in FIG. 1 is a plain paper sheet, the paper sheet P with cuts may be bent after an image is formed on its surface by conveying it to an image forming apparatus such as a printer or a copier.

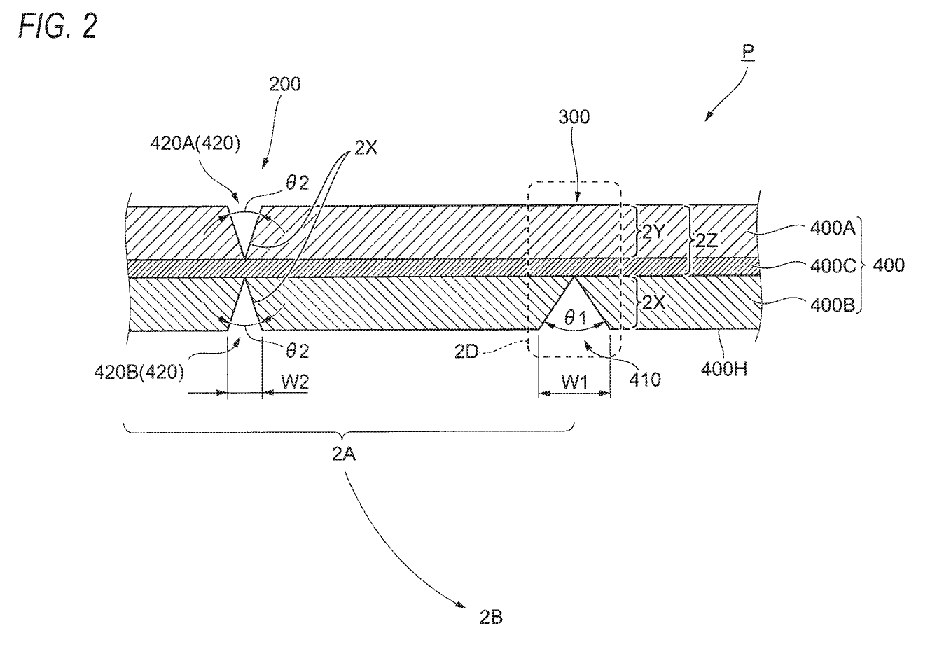

FIG. 2 is a sectional view of the paper sheet P taken along line II-II in FIG. 1. As shown in FIG. 2, the paper sheet P according to the exemplary embodiment has a paper sheet body 400, bending cuts 410, and separating cuts 420.

The paper sheet body 400, which is an example of the “sheet body”, has a three-layer structure, that is, consists of a front-side sheet 400A, a back-side sheet 400B, and a bonding layer (adhesive layer) 400C.

The back-side sheet 400B which is disposed on one side and is an example of the “one side layer” is made of paper. The front-side sheet 400A which is disposed on the other side and is an example of the “the other side layer” is also made of paper. The bonding layer 400C is sandwiched between the front-side sheet 400A and the back-side sheet 400B and bonds them together.

Although the exemplary embodiment is directed to an example case that the front-side sheet 400A and the back-side sheet 400B are made of paper, the invention is not limited to this case and the front-side sheet 400A and the back-side sheet 400B may be made of any of synthetic paper, film, unwoven fabric, etc. In other words, although the exemplary embodiment is directed to the paper sheet P as an example of the “sheet”, structures described in the exemplary embodiment can also be applied to sheets other than paper sheets, more specifically, sheets made of any of synthetic paper, film, unwoven fabric, etc.

Although the exemplary embodiment is directed to the case that the bonding layer 400C is sandwiched between the paper layers, the bonding layer 400C may be sandwiched between a paper layer and a layer made of a material other than paper.

Each of the front-side sheet 400A and the back-side sheet 400B may be either a single layer such as a single paper or film layer or a multiple layer formed by laminating plural, different kinds of paper or film layers.

The bending cuts 410 are formed in the back-side sheet 400B. Each bending cut 410 is formed in a part, in the thickness direction, of a portion, to be subjected to bending, of the paper sheet body 400

In the exemplary embodiment, in a sectional view taken perpendicularly to the surfaces of the paper sheet P, each portion to be subjected to bending has a part of the bonding layer 400C that lies between a portion that is formed with a bending cut 410 and a portion that is not with a bending cut 410.

More specifically, in a sectional view taken perpendicularly to the surfaces of the paper sheet P, there exists, in a region 2D (see FIG. 2), a part of the bonding layer 400C that lies between a portion 2X that is formed with a bending cut 410 and a portion 2Y that is not with a bending cut 410. The bending cut 410 reaches to a position close to the bonding layer 400C in the thickness direction of the paper sheet P.

The bending cut 410 is formed so as to leave at least part, in the thickness direction, of the associated part of the bonding layer 400C. In other words, the bending cut 410 is formed so as not to divide the bonding layer 400C; even if the bending cut 410 is formed so as to go into the bonding layer 400C, at least part, in the thickness direction, of the associated part of the bonding layer 400C remains undivided (i.e., the bending cut 410 does not reach there).

In the exemplary embodiment, the portion, not formed with the bending cut 410, of the bonding layer 400C has such a thickness (in the direction perpendicular to the surfaces of the paper sheet P) as to be strong enough to prevent division of the paper sheet P there. That is, in the exemplary embodiment, as described above, the bending cut 410 may reach the bonding layer 400C. In such a case, the portion, not formed with the bending cut 410, of the bonding layer 400C has such a thickness as to be strong enough to prevent division of the paper sheet P there.

In the exemplary embodiment, each bending cut 410 is formed in a portion that will be placed inside when the paper sheet P is subjected to bending. For example, referring to FIG. 2, the paper sheet P is bent by moving a portion 2A in a direction 2B, as a result of which the back-side sheet 400B comes to be located inside. The bending cuts 410 are formed in the back-side sheet 400B which will be located inside.

In the exemplary embodiment, the box-shaped object 100 is formed as shown in part (B) of FIG. 1. The bending cuts 410 will be located inside the object 100. With this measure, the bending cuts 410 are not exposed to the outside of the object 100, which prevents degradation of the appearance of the object 100 due to the bending cuts 410.

Although in FIG. 2 the bending cuts 410 are formed in the back-side sheet 400B, a bending cut 410 may be formed in the front-side sheet 400A for a certain bending direction of the paper sheet P. For example, where the paper sheet P is to be bent by moving the portion 2A upward in FIG. 2, a bending cut 410 is formed in the front-side sheet 400A.

Where plural bending portions 300 are formed, there may occur a case that the paper sheet P is bent toward one side in one bending portion 300 and toward the other side in another bending portion 300.

In either case, in each bending portion 300, the bending cut 410 is formed on such a side as to be placed inside when the paper sheet P is bent there.

Each of a set of FIGS. 3-1A to 3-1C and a set of FIGS. 3-1D to 3-1F shows, as a comparative example, how a bending portion 300 and its neighborhood of a paper sheet P behave in a case that the bending portion 300 is formed with a score 320. In the examples of FIGS. 3-1A to 3-1C and FIGS. 3-1D to 3-1F, a paper sheet body 400 consists of a front-side sheet 400A, a back-side sheet 400B, and a bonding layer 400C, in the same manner as described above. The score 320 is formed by crushing the paper sheet P partially by pressing a die (not shown) against it.

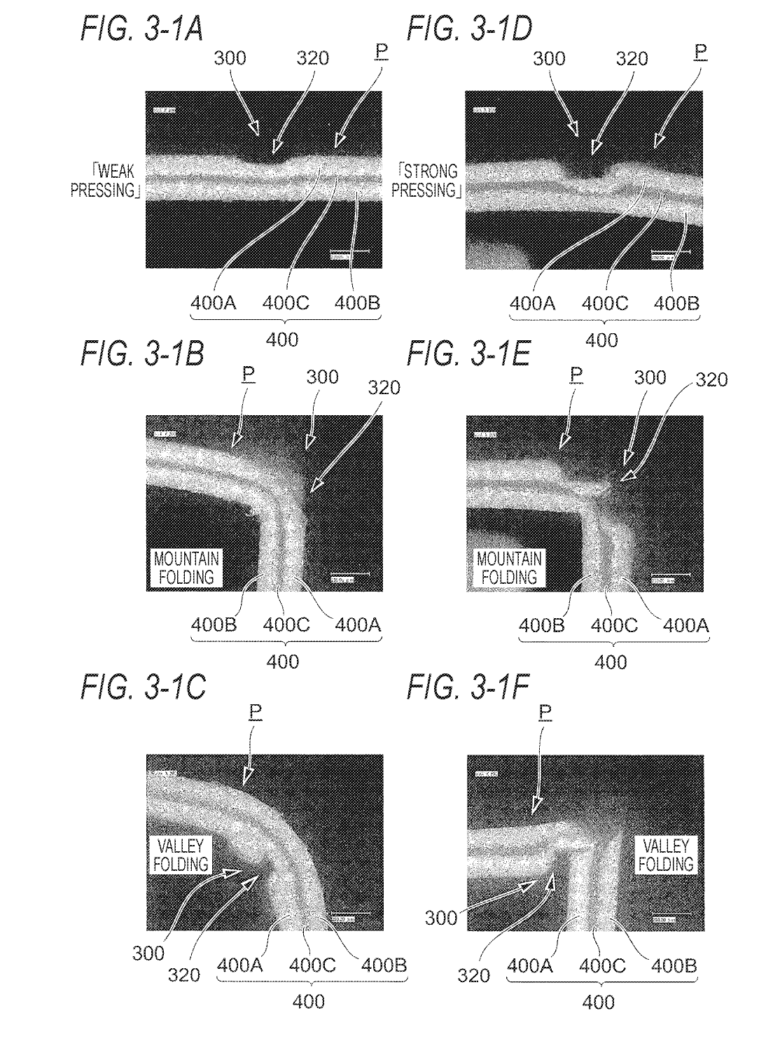

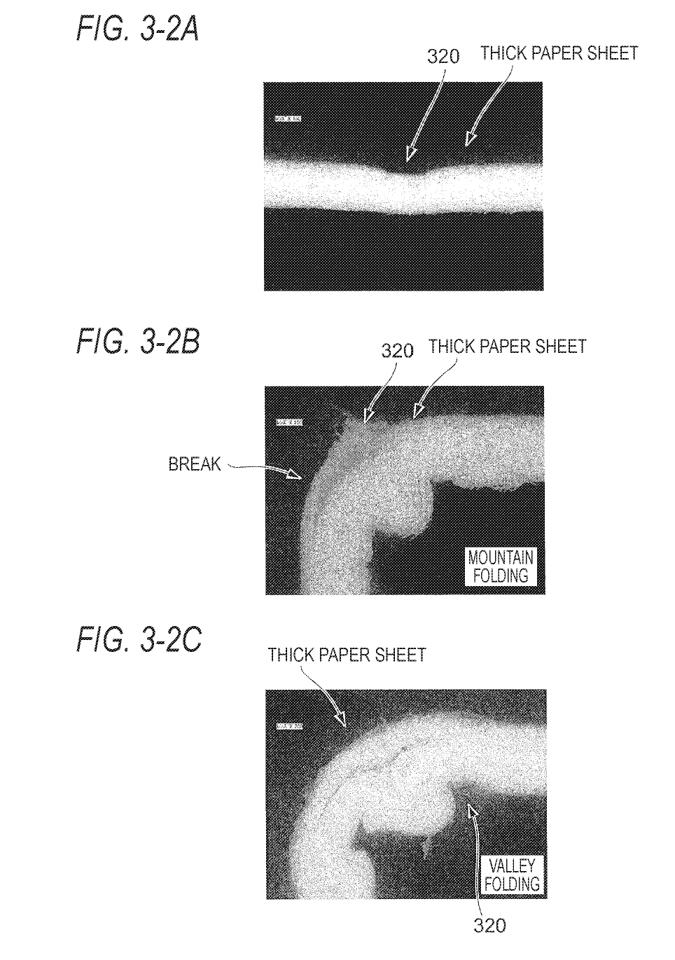

FIG. 3-1A shows a case that the paper sheet body 400 having the bonding layer 400C is formed with a shallow score 320 (formed by weak pressing). In this case, the score 320 is formed only in a surface layer of the front-side sheet 400A.

When the paper sheet P shown in FIG. 3-1A was mountain-folded with the score 320 located outside, as shown in FIG. 3-1B fuzz and fine splinters occur on the surface of the front-side sheet 400A of the bent paper sheet P.

FIG. 3-1C shows a case that the paper sheet P shown in FIG. 3-1A was valley-folded intentionally with the score 320 located inside (in general, it is mountain-folded). Since the score 320 was shallow, it was difficult to valley-fold the paper sheet P. It was found that if a paper sheet is valley-folded forcibly with a shallow score located inside, a break or creases are prone to occur there.

FIG. 3-1D shows a case that the paper sheet body 400 having the bonding layer 400C is formed with a deep score 320 (formed by strong pressing). In this case, the score 320 reaches the bonding layer 400C. In the portion that is formed with the score 320, the front-side sheet 400A, the back-side sheet 400B, and the bonding layer 400C are compressed and made thinner.

When the paper sheet P was mountain-folded with the score 320 located outside, as shown in FIG. 3-1E the front-side sheet 400A (i.e., the outside layer) was broken.

As shown in FIG. 3-1F, the back-side sheet 400B was broken when the paper sheet P was valley-folded with the score 320 located inside.

In the exemplary embodiment in which the paper sheet P has the bonding layer 400C as the middle layer, an elastic body exists in the paper sheet Pat the middle. In this case, when a die is pressed against the sheet P to form a score 320, part of the pressing load acting on the paper sheet P serves to deform the bonding layer 400C elastically and hence the front-side sheet 400A is not compressed easily.

In this case, as shown in FIG. 3-1A, the front surface of the paper sheet P tends to be formed with a shallow score 320. As a result, as described above with reference to FIGS. 3-1B and 3-1C, fuzz or creases are prone to occur in the paper sheet P.

The above problem can be solved by increasing the die pressing load. However, with this measure, the front-side sheet 400A, the back-side sheet 400B, and the bonding layer 400C are compressed and made thinner in the portion involved. If such a paper sheet P is bent, as described above the outside layer of the sheet P is prone to break.

In contrast, in the exemplary embodiment in which the bending cuts 410 are formed, the paper sheet P can be bent while formation of creases and breaking of the paper sheet P are prevented.

FIGS. 3-2A to 3-2C show, as a comparative example, how a common thick paper sheet formed with a score 320 behaves when it is bent. Although the thick paper sheet of this comparative example is formed with the score 320, the depth, width, etc. of the score 320 are not suitable for the thickness of the thick paper sheet. FIGS. 3-2A to 3-2C show how the thick paper sheet behaves when it is bent while receiving a heavy load.

FIG. 3-2A shows a state before the thick paper sheet was bent. One surface of the thick paper sheet was formed with the score 320.

FIG. 3-2B shows a state of the thick paper sheet when it was mountain-folded with the score 320 located outside. The portion formed with the score 320 is compressed and made thinner, and as shown in FIG. 3-2B the thick paper sheet is prone to break in its surface layer (outermost layer).

FIG. 3-2C shows a state of the thick paper sheet when it was valley-folded with the score 320 located inside. In this case, although the thick paper sheet was not broken, it was hard to bend because the score 320 was shallow. If the thick paper sheet is bent further from the state of FIG. 3-2C, creases or a break is prone to occur.

In contrast, in the exemplary embodiment in which the bending cuts 410 are formed, as mentioned above, the paper sheet P can be bent while formation of creases and breaking of the paper sheet P are prevented.

In thick paper sheets, paper sheets having a bonding layer, and like sheets, even if a score is formed, there may occur a situation that the score does not serve as a guide for bending and creases or a break is prone to occur in a portion bent. In contrast, in the exemplary embodiment, the paper sheet P can be bent while formation of creases, breaking, etc. are prevented.

Next, the separating cuts 420 will be described. As shown in FIG. 2, the separating cuts 420 are formed in the front-side sheet 400A and the back-side sheet 400B.

In the exemplary embodiment, the separating cuts 420 (called “back-side separating cuts 420B” where appropriate) are formed in the back-side sheet 400B, that is, on the back side of the separating cuts 420 (called “front-side separating cuts 420A” where appropriate) that are formed in the front-side sheet 400A.

In other words, each back-side separating cut 420B is formed at such a position as to be opposed to the associated front-side separating cut 420A parallel with it with the bonding layer 400C interposed between them. That is, the paper sheet P is formed with the front-side separating cuts 420A and is also formed with the back-side separating cuts 420B which, together with the front-side separating cuts 420A, allow the paper sheet P to be divided along them.

From another point of view, in the exemplary embodiment, the back-side sheet 400B is formed with the back-side separating cuts 420B, which are an example of the “the other cut”, are formed at different positions than the bending cuts 410. Furthermore, each front-side separating cut 420A is formed at such a position as to be opposed, from the front side, to the associated back-side separating cut 420B parallel with it.

In the exemplary embodiment, each of the bending cuts 410 and the separating cuts 420 is shaped like a triangle in cross section in such a manner that its width increases as the position goes from the inside (i.e., the side closer to the bonding layer 400C) to the front or back surface of the paper sheet body 400 in the thickness direction of the paper sheet body 400. However, this is just an example; each of the bending cuts 410 and the separating cut 420 may be shaped like a slit.

In the exemplary embodiment, the paper sheet P is divided (cut) at the separating portions 200 by a user's applying an external force to the paper sheet P.

At each separating portion 200, the front-side sheet 400A and the back-side sheet 400B have already been divided (cut) almost fully by the separating cuts 420 and hence the bonding layer 400C is to be divided mainly. Thus, the user can divide the paper sheet P by a weak force.

In the exemplary embodiment in which the bonding layer 400C is to be divided mainly, it is avoided that the paper sheet P is divided in such a manner that (the fiber constituting) each of the front-side sheet 400A and the back-side sheet 400B is teared up. Thus, the user can divide the paper sheet P by a weak force.

In the exemplary embodiment in which it is avoided that the paper sheet P is divided in such a manner that each of the front-side sheet 400A and the back-side sheet 400B is teared up, division result surfaces, in the separating portions 200, of a separated part of the paper sheet P are smoother than in a case that the paper sheet P is divided in such a manner that each of the front-side sheet 400A and the back-side sheet 400B is teared up. When the user touches a division result surface, in a separating portion 200, of the separated part of the paper sheet P, he or she would get a better feeling than in a case that the paper sheet P is divided in such a manner that each of the front-side sheet 400A and the back-side sheet 400B is teared up.

In the exemplary embodiment, each of the bending cuts 410 and the separating cuts 420 is formed in the direction from the front or back surface of the paper sheet body 400 to the inside in the thickness direction of the paper sheet body 400 in such a manner that the width of each of the bending cuts 410 and the separating cuts 420 at the front or back surface of the paper sheet body 400 is greater than at its inside.

In the exemplary embodiment, each of the bending cuts 410 and the separating cuts 420 is shaped like a triangle in cross section in such a manner that its width increases as the position goes from the inside of the paper sheet body 400 to its front or back surface. However, each of the bending cuts 410 and the separating cuts 420 may be shaped like a hemisphere or a trapezoid.

Each of the bending cuts 410 has an opening angle θ1, and each of the separating cut 420 has an opening angle θ2.

As shown in FIG. 2, unlike a slit, as described above each of the bending cuts 410 is formed in such a manner that the width at the back surface of the paper sheet body 400 is greater than at its inside. This allows the paper sheet P to be bent more easily than in a case that each of the bending cut 410 is shaped like a slit.

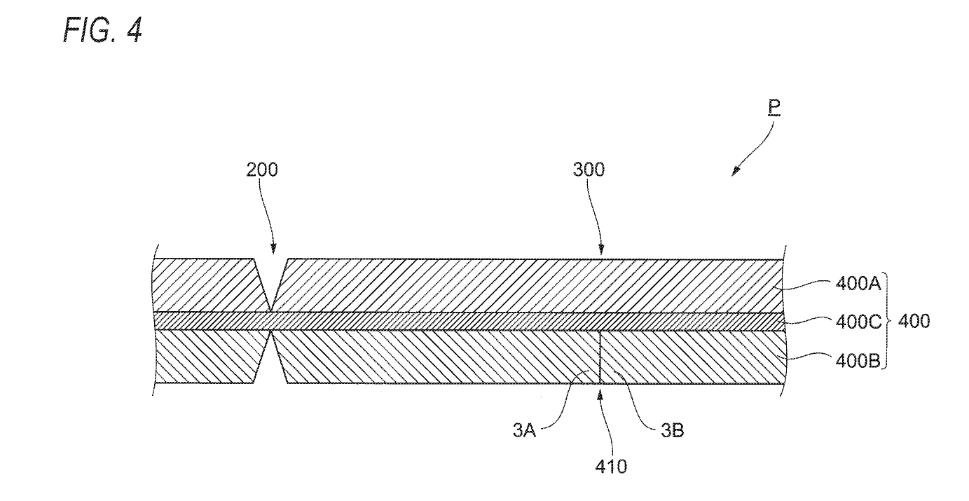

FIG. 4 shows a paper sheet P having another example configuration which is formed with slit-shaped bending cuts 410. Where each bending cut 410 is shaped like a slit, portions 3A and 3B which are on the two respective sides of the slit interfere with each other when the paper sheet P is bent. Thus, the paper sheet P is hard to bend. In contrast, the paper sheet P shown in FIG. 2 is not prone to such interference and hence can be bent easily.

It is preferable that the opening angle θ1 (see FIG. 2) of each bending cut 410 be in a range of 40° to 100°. In many cases, the paper sheet P is bent by 90° at each bending portion 300, in which case interference is prone to occur as in the case of a slit if the opening angle θ1 is smaller than 40°. On the other hand, if the opening angle θ1 is larger than 100°, the paper sheet P is prone to bend excessively, in which case the object 100 is prone to lose its original shape.

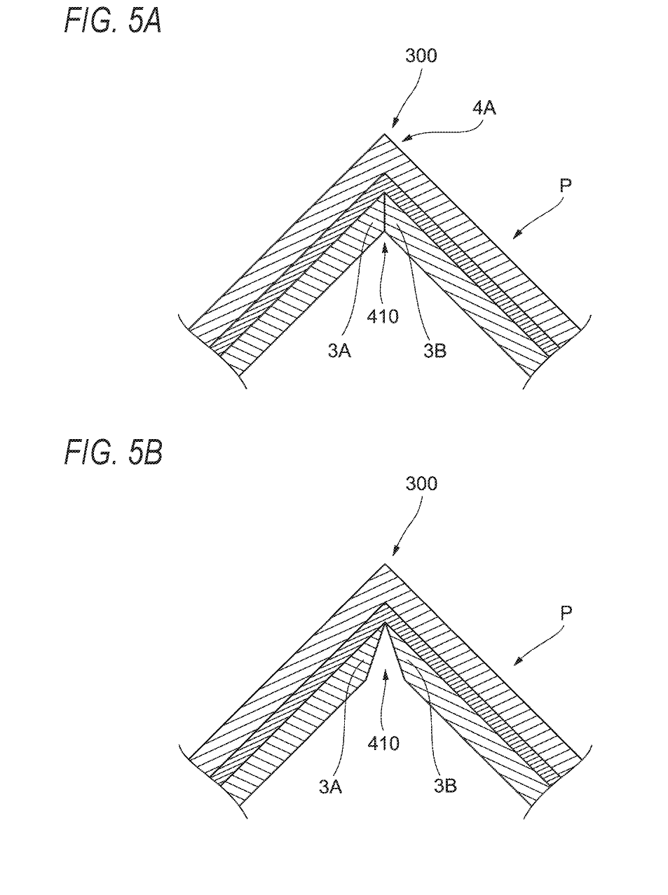

FIGS. 5A and 5B show respective states of a bending portion 300 as subjected to bending. For example, where the opening angle θ1 of each bending cut 410 is equal to 90°, after bending, as shown in FIG. 5A portions 3A and 3B located on the two respective sides of each bending cut 410 come into contact with each other. In this case, the paper sheet P is less prone to deform there. Where bent portions are desired to be kept at right angles, this paper sheet P is preferable and the object 100 is kept stable in shape.

On the other hand, where the opening angle θ1 of each bending cut 410 is larger than 100°, after bending, as shown in FIG. 5B a gap is formed between portions 3A and 3B located on the two respective sides of the bending cut 410 of each bending portion 300. In this case, the paper sheet P is more prone to deform there and the object 100 is more prone to lose its original shape than in the case that the portions 3A and 3B located on the two respective sides of each bending cut 410 come into contact with each other.

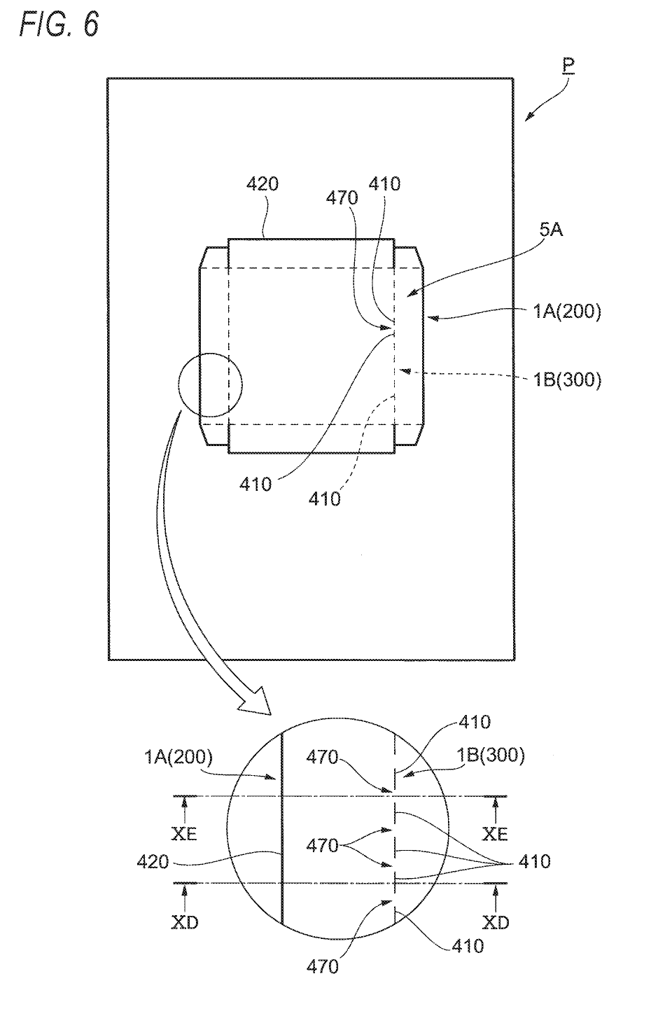

Although in the example shown in FIGS. 1 and 2 each bending cut 410 is a continuous cut, each bending cut 410 may be formed as plural cuts that are separated from each other. More specifically, as shown in FIG. 6 which shows a paper sheet P having another example configuration, each bending cut 410 may be formed like perforations.

In the example configuration shown in FIG. 6, each bending cut 410 (also denoted by symbol 5A) is formed as plural cuts that are arranged along the bending portion 300 and a non-cut portion 470 is formed between adjacent cuts. In this example configuration, each bending portion 300 is stronger than in the case that each bending cut 410 is a continuous cut.

It is preferable that the length of each non-cut portion 470 (i.e., the distance between adjacent cuts of each bending cut 410) be 0.3 to 1.0 mm.

A bending portion 300 is made weaker if a certain number of cuts that are spaced from each other by a distance shorter than the above range are formed adjacent to each other. On the other hand, if a certain number of cuts that are spaced from each other by a distance longer than the above range are formed adjacent to each other, these cuts are less likely form a straight line when the paper sheet P is bent there.

Parts (A)-(D) of FIG. 7 illustrate a bending portion 300 having another example structure in which plural (two) bending cuts 410 are formed at a bending portion 300. As shown in part (A) of FIG. 7, a bending portion 300 have plural bending cuts 410 that are spaced from each other in the direction perpendicular to the extending direction of the bending portion 300 which is perpendicular to the paper surface of FIG. 7.

In other words, in this example structure, the plural bending cuts 410 extend along the bending portion 300 so as to be spaced from each other in the direction perpendicular to their extending directions. The paper sheet P is bent along a straight line along whichever of the plural bending cuts 410 the paper sheet P is bent.

In the example structure shown in part (A) of FIG. 7, the degree of recovery of each bent portion of the paper sheet P as subjected to bending is low.

Where each bending cut 410 is a single continuous cut, when the paper sheet P is bent there by 90°, there may occur an event that as shown in parts (C) and (D) of FIG. 7 the bent portion recovers due to the stiffness of the paper sheet P and its bend angle is made larger than 90°.

In contrast, where as shown in part (A) of FIG. 7 the plural bending cuts 410 are formed so as to be spaced from each other in the direction perpendicular to their extending directions, the bend angle of the paper sheet P becomes approximately equal to 90° at the bending portion 300 (see part (B) of FIG. 7) though the bend angle is larger than 90° at each bending cut 410.

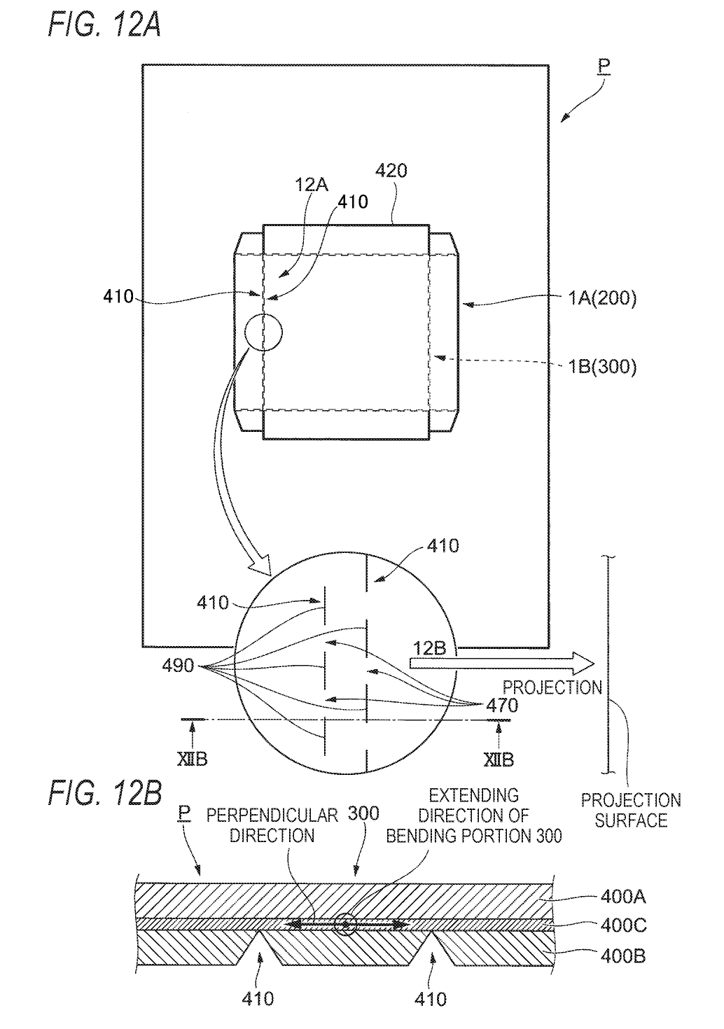

FIGS. 12A and 12B show a paper sheet P having another example configuration in which plural (two) bending cuts 410 are formed so as to be spaced from each other in the direction perpendicular to their extending directions. FIG. 12A is a front view of a paper sheet P, and FIG. 12B is a sectional view taken along line XIIB-XIIB in FIG. 12A.

In this example configuration, plural (two) perforates-shaped bending cuts 410 (also indicated by a line 12A) extend in the vertical direction in FIG. 12A in such a manner that each bending cut 410 has cuts 490 and non-cut portions 470 that are arranged alternately.

The plural perforates-shaped bending cuts 410 are formed parallel with each other so as to be spaced from each other in the direction perpendicular to their extending directions.

Furthermore, in this example configuration, as shown in FIG. 12A, the plural perforates-shaped bending cuts 410 are formed in such a manner that the bending cuts 490 of the left-hand bending cut 410 and those of the right-hand bending cut 410 are arranged in a staggered manner.

Still further, the plural perforates-shaped bending cuts 410 are formed in such a manner that the bending cuts 490 of the left-hand bending cut 410 overlap with those of the right-hand bending cut 410. In other words, when the two perforates-shaped bending cuts 410 are projected in the direction perpendicular to their extending directions as indicated by arrow 12B in FIG. 12A, the bending cuts 490 belonging to one bending cut 410 and those belonging to the other bending cut 410 form a continuous straight line.

In the configuration shown in FIGS. 12A and 12B, as in the example configuration shown in parts (A) and (B) of FIG. 7, the degree of recovery of each bent portion of the paper sheet P as subjected to bending is low.

Furthermore, since the bending cuts 410 are formed like perforations, each bending portion 300 as subjected to bending is stronger than in the case that the bending cuts 410 are continuous straight cuts.

Still further, as mentioned above, when the two perforates-shaped bending cuts 410 are projected in the direction perpendicular to their extending directions, the bending cuts 490 belonging to one bending cut 410 and those belonging to the other bending cut 410 form a continuous straight line. As a result, each bending portion 300 of the paper sheet P is made lower in stiffness and the paper sheet P becomes easier to bend than in a case that the bending cuts 490 belonging to one bending cut 410 and those belonging to the other bending cut 410 do not forma continuous straight line.

Incidentally, in the exemplary embodiment, as shown in FIG. 2, the front-side sheet 400A is the same in thickness as the back-side sheet 400B. However, they may be different from each other in thickness. More specifically, for example, the front-side sheet 400A which is to be located outside in the object 100 may be thinner than the back-side sheet 400B which is to be located inside.

In other words, the front-side sheet 400A which is opposite to the back-side sheet 400B which is formed with the bending cuts 410 may be made thinner than the back-side sheet 400B. With this measure, the paper sheet P is made easier to bend than in a case that the front-side sheet 400A which is to be placed outside by bending is thicker than the back-side sheet 400B.

Where the front-side sheet 400A is thinner than the back-side sheet 400B, the paper sheet P is less prone to break than in a case that the front-side sheet 400A is thicker than the back-side sheet 400B. More specifically, the paper sheet P is less prone to break (tear) in an apex portion of a bending portion 300 (i.e., a projection-side portion of a bending portion 300 such as a portion 4A in FIG. 5A).

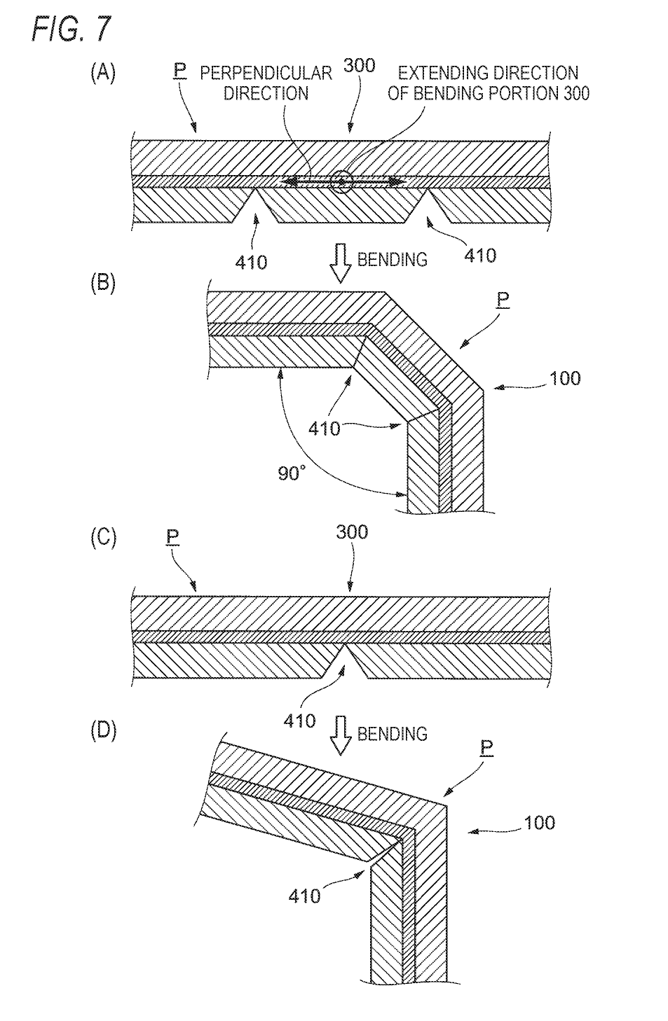

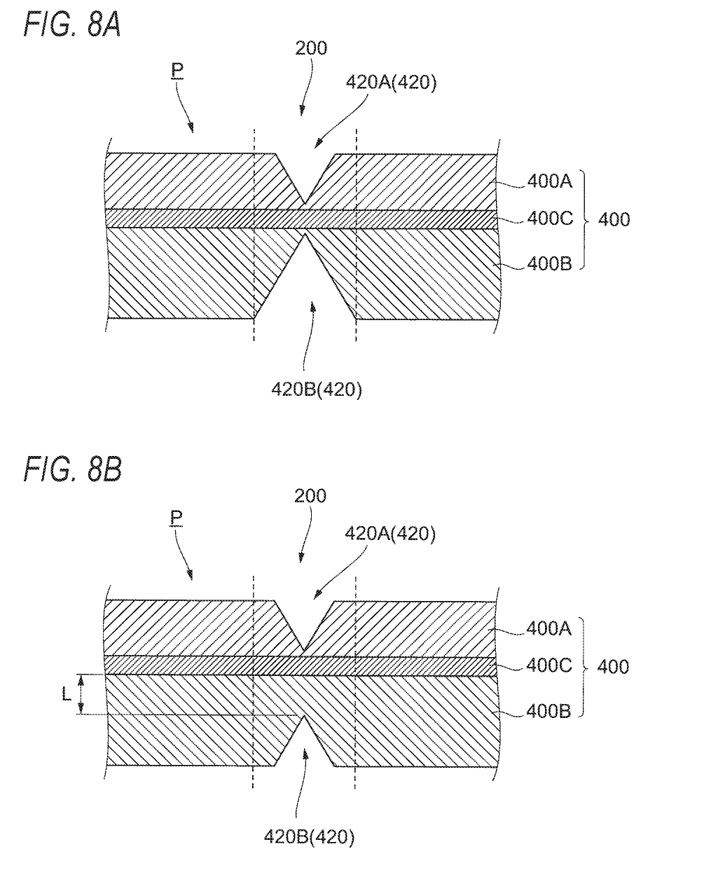

FIGS. 8A and 8B illustrate a paper sheet P having another example configuration in which only a separating portion 200 is shown, that is, a bending portion 300 is not shown.

In this example configuration, the front-side sheet 400A is thinner than the back-side sheet 400B. Furthermore, in the example configuration shown in FIG. 8A, the cutting length (depth) of a back-side separating cut 420B which is an example of the “first cut” is greater than that of a front-side separating cut 420A which is an example of the “second cut”.

If the cutting length of the front-side separating cut 420A is the same as that of the back-side separating cut 420B in the case that the front-side sheet 400A is thinner than the back-side sheet 400B, as shown in FIG. 8B the distance L between the back-side separating cut 420B and the bonding layer 400C is long. In this case, when the paper sheet P is subjected to dividing (cutting), it is divided in such a manner that (the fiber constituting) the back-side separating cut 420B is teared up and hence the separating portion 200 is prone to get rough.

In contrast, where as shown in FIG. 8A the cutting length of the back-side separating cut 420B is greater than that of the front-side separating cut 420A, the back-side separating cut 420B extends close to the bonding layer 400C. In this case, the region where the back-side sheet 400B breaks (i.e., the region where the back-side sheet 400B breaks in such a manner that the fiber constituting it is teared up) is small and hence the degree of roughness of the separating portion 200 as subjected to dividing is low.

FIG. 9 shows a paper sheet P having still another example configuration in which a bending portion 300 is not shown.

As shown in part (A) of FIG. 9, a back-side separating cut 420B has an opening 400S in the surface of the back-side sheet 400B and a front-side separating cut 420A has an opening 400T in the surface of the front-side sheet 400A. In this example configuration, opening edges 400Y of the front-side separating cut 420A are opposed to opening edges 400X of the back-side separating cut 420B, respectively, with the bonding layer 400C interposed in between.

More specifically, in this example configuration, the opening edges 400X of the back-side separating cut 420B and the opening edges 400Y of the front-side separating cut 420A are located on straight broken lines 8A and 8B drawn in part (A) of FIG. 9 which extend in the thickness direction of the paper sheet P. That is, the opening edges 400X of the back-side separating cut 420B coincide with the opening edges 400Y of the front-side separating cut 420A, respectively, when they are projected in the thickness direction of the paper sheet P.

Furthermore, so that the width WX of the back-side separating cut 420B in the surface of the back-side sheet 400B becomes close to the width WY of the front-side separating cut 420A in the surface of the front-side sheet 400A, the sectional shape of the back-side separating cut 420B in a plane perpendicular to the extending direction of the separating cut 420 is made different from that of the front-side separating cut 420A.

In other words, the width WX of the back-side separating cut 420B in the surface of the back-side sheet 400B is made close to the width WY of the front-side separating cut 420A in the surface of the front-side sheet 400A by making the sectional shape of the back-side separating cut 420B like a triangle that is longer in the vertical direction in part (A) of FIG. 9 and making the sectional shape of the front-side separating cut 420A like a triangle that is longer in the horizontal direction in part (A) of FIG. 9.

In this example configuration, as in the example configuration illustrated in FIGS. 8A and 8B, the front-side sheet 400A is thinner than the back-side sheet 400B.

In this example configuration, the front-side separating cut 420A formed in the front-side sheet 400A is shallower than the back-side separating cut 420B formed in the back-side sheet 400B.

Furthermore, in this example configuration, the opening angle θA of the front-side separating cut 420A formed in the front-side sheet 400A is larger than the opening angle θB of the back-side separating cut 420B formed in the back-side sheet 400B.

More specifically, in the back-side separating cut 420B which is an example of the “first cut”, the width WX in the surface of the back-side sheet 400B is greater than the widths of its inside portion (close to the bonding layer 400C) in the thickness direction of the back-side sheet 400B. And the back-side separating cut 420B has the opening angle θB.

Likewise, in the front-side separating cut 420A which is an example of the “second cut”, the width WY in the surface of the front-side sheet 400A is greater than the widths of its inside portion in the thickness direction of the front-side sheet 400A. And the front-side separating cut 420A has the opening angle θA.

In this example configuration, the opening angle θA of the front-side separating cut 420A is larger than the opening angle θB of the back-side separating cut 420B. The opening angle of a cut is defined in a sectional view as an angle that is formed by one straight line that connects one edge, closer to the valley bottom, of one side surface facing the cut and the other edge, closer to the cut opening, of the one side surface and the other straight line that connects one edge, closer to the valley bottom, of the other side surface facing the cut and the other edge, closer to the cut opening, of the other side surface.

A more specific description will be made with reference to part (A) of FIG. 9. The opening angle θA is an angle that is formed by one straight line 492 that connects one edge 401A, closer to the valley bottom 491, of one side surface 401 facing the front-side separating cut 420A and the other edge 401B, closer to a cut opening 400T, of the one side surface 401 and the other straight line 493 that connects one edge 402A, closer to the valley bottom 491, of the other side surface 402 facing the front-side separating cut 420A and the other edge 402B, closer to the cut opening 400T, of the other side surface 402.

In other words, the opening angle θA is an angle that is formed by the one straight line 492 that connects the valley bottom 491 and the one opening edge 400Y (located on the right side in part (A) of FIG. 9) and the other straight line 493 that connects the valley bottom 491 and the other opening edge 400Y (located on the left side in part (A) of FIG. 9).

The opening angle θB is an angle that is formed by one straight line 496 that connects one edge 403A, closer to the valley bottom 495, of one side surface 403 facing the rear-side separating cut 420B and the other edge 403B, closer to a cut opening 400S, of the one side surface 403 and the other straight line 497 that connects one edge 404A, closer to the valley bottom 495, of the other side surface 404 facing the rear-side separating cut 420B and the other edge 404B, closer to the cut opening 400S, of the other side surface 404.

In other words, the opening angle θB is an angle that is formed by the one straight line 496 that connects the valley bottom 495 and the one opening edge 400X (located on the right side in part (A) of FIG. 9) and the other straight line 497 that connects the valley bottom 495 and the other opening edge 400X (located on the left side in part (A) of FIG. 9).

Although this example configuration has the front-side separating cut 420A and the back-side separating cut 420B which are triangular in cross section, they may have any of other sectional shapes such as a trapezoid.

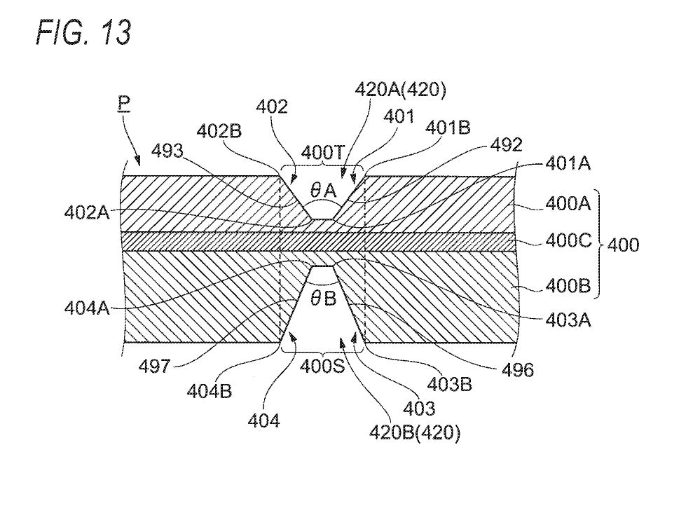

FIG. 13 shows separating cuts 420 having other structures, that is a front-side separating cut 420A and a back-side separating cut 420B which are trapezoidal in cross section.

In this case, the opening angle θA is an angle that is formed by one straight line 492 that connects one edge 401A of one side surface 401 facing the front-side separating cut 420A and the other edge 401B of the one side surface 401 and the other straight line 493 that connects one edge 402A of the other side surface 402 facing the front-side separating cut 420A and the other edge 402B of the other side surface 402.

The opening angle θB is an angle that is formed by one straight line 496 that connects one edge 403A of one side surface 403 facing the rear-side separating cut 420B and the other edge 403B of the one side surface 403 and the other straight line 497 that connects one edge 404A of the other side surface 404 facing the rear-side separating cut 420B and the other edge 404B of the other side surface 404.

In the example configuration shown in part (A) of FIG. 9, the paper sheet P is divided at a portion 8E. Part (B) of FIG. 9 shows the paper sheet P as divided in which each of separated parts, shown on the left side and the right side in Part (B) of FIG. 9, of the paper sheet P has two edges 8F and 8G.

In this example configuration, a positional difference between the edges 8F and 8G in the direction perpendicular to the thickness direction of the paper sheet P (i.e., in the left-right direction in part (B) of FIG. 9) is small. In this case, a touch a user feels when he or she touches the surface of the separating portion 200 as cut from the side of one surface of the paper sheet P would be similar to a touch the user feels when he or she touches the surface of the separating portion 200 as cut from the side of the other surface of the paper sheet P.

Part (C) of FIG. 9 shows a case that the width WX of the back-side sheet 400B in the surface of the back-side sheet 400B is different from the width WY of the front-side separating cut 420A in the surface of the front-side sheet 400A. In this case, a positional difference between the edges 8F and 8G is large. As a result, a touch a user feels when he or she touches the surface of the separating portion 200 as cut from the side of one surface of the paper sheet P tends to be different from a touch the user feels when he or she touches the surface of the separating portion 200 as cut from the side of the other surface of the paper sheet P. As a result, the user likely feels uncomfortable.

In this example configuration, as described above with reference to part (A) of FIG. 9, the opening edges 400Y of the front-side separating cut 420A are opposed to the opening edges 400X of the back-side sheet 400B. In this case, the positions of the two edges 8F and 8G in the direction perpendicular to the thickness direction of the paper sheet P coincide with each other more exactly, whereby a user would get an even less uncomfortable feeling.

Referring to FIG. 2 again, the paper sheet P according to the exemplary embodiment will be described below in further detail.

In the paper sheet P according to the exemplary embodiment, as shown in FIG. 2, the separating cuts 420 of each separating portion 200 and the bending cut 410 of each bending portion 300 are arranged in different manners. More specifically, whereas in each separating portion 200 the separating cuts 420 are formed in the front-side sheet 400A and the back-side sheet 400B, respectively, in each bending portion 300 the bending cut 410 is formed only in the back-side sheet 400B.

In the paper sheet P according to the exemplary embodiment, the separating cuts 420 of each separating portion 200 are different in shape from the bending cut 410 of each bending portion 300. More specifically, the separating cuts 420 of each separating portion 200 are shaped like a triangle that is long in the vertical direction in FIG. 2 and the bending cut 410 of each bending portion 300 is shaped like a triangle that is long in the horizontal direction.

In the paper sheet P according to the exemplary embodiment, the opening angle θ2 of the separating cuts 420 of each separating portion 200 is different from the opening angle θ1 of the bending cut 410 of each bending portion 300. More specifically, the opening angle θ2 of the separating cuts 420 of each separating portion 200 is larger than the opening angle θ1 of the bending cut 410 of each bending portion 300.

Furthermore, In the paper sheet P according to the exemplary embodiment shown in FIG. 2, the width W2, at the surfaces of the paper sheet body 400, of the separating cuts 420 of each separating portion 200 in the direction perpendicular to the thickness direction of the paper sheet P is different from the width W1 of the bending cut 410 of each bending portion 300. More specifically, the width W2 of the separating cuts 420 of each separating portion 200 is smaller than the width W1 of the bending cut 410 of each bending portion 300.

Although in FIG. 2 the separating portions 200 are different from the bending portions 300 in the manner of arrangement and the shape of cuts, the former may be different from the latter only in one of the manner of arrangement and the shape of cuts.

An example of the case that the separating portions 200 are the same as the bending portions 300 in the manner of arrangement of cuts is that also in each bending portion 300 a bending cut 410 is formed in both of the front-side sheet 400A and the back-side sheet 400B. In this case, the bending portions 300 are made weaker and hence the paper sheet P likely breaks at a bending portion 300 after being bent.

Another example of the case that the separating portions 200 are the same as the bending portions 300 in the manner of arrangement of cuts is that in each separating portion 200 a separating cut 420 is formed only in the back-side sheet 400B. In this case, the paper sheet P is divided in such a manner that (the fiber constituting) the front-side sheet 400A is teared up and hence a division-formed surface of the paper sheet P is prone to get rough.

In contrast, in the exemplary embodiment in which the separating cuts 420 of the separating portions 200 are arranged differently from the bending cuts 410 of the bending portions 300, an event can be avoided that the paper sheet P is divided at a bending portion 300 or a division-formed surface of the paper sheet P gets rough.

Furthermore, in the paper sheet P according to the exemplary embodiment, as described above, the separating cuts 420 of each separating portion 200 are different in shape from the bending cut 410 of each bending portion 300.

More specifically, the width W2 of the separating cuts 420 of each separating portion 200 is different from the width W1 of the bending cut 410 of each bending portion 300. That is, the width W2 of the separating cuts 420 is smaller than the width W1 of the bending cut 410.

Furthermore, the opening angle θ2 of the separating cuts 420 of each separating portion 200 is smaller than the opening angle θ1 of the bending cut 410 of each bending portion 300.

Where the width W2 of the separating cuts 420 of each separating portion 200 is smaller than the width W1 of the bending cut 410 of each bending portion 300 (i.e., the opening angle θ2 of the separating cuts 420 of each separating portion 200 is smaller than the opening angle θ1 of the bending cut 410 of each bending portion 300), when each separating portion 200 is divided, stress is concentrated on it more easily and hence the working load that is necessary for the dividing is made smaller than in a case that the width W2 is larger than the width W1. More specifically, stress is concentrated easily on the portion corresponding to the portion 8E shown in part (A) of FIG. 9 and hence the working load that is necessary for dividing is made small.

Where the width W2 of the separating cuts 420 of each separating portion 200 (see FIG. 2) is smaller than the width W1 of the bending cut 410 of each bending portion 300, the angle formed by an end surface of the paper sheet P as divided and the front surface or back surface of the paper sheet P can be made closer to the right angle.

On the other hand, where the width W1 of the bending cut 410 of each bending portion 300 (see FIG. 2) is larger than the width W2 of the separating cuts 420 of each separating portion 200 (i.e., the opening angle θ1 of the bending cut 410 of each bending portion 300 is larger than the opening angle θ2 of the separating cuts 420 of each separating portion 200), as described above portions located on the two respective sides of the bending cut 410 are less prone to interfere with each other and hence the paper sheet P is easy to bend.

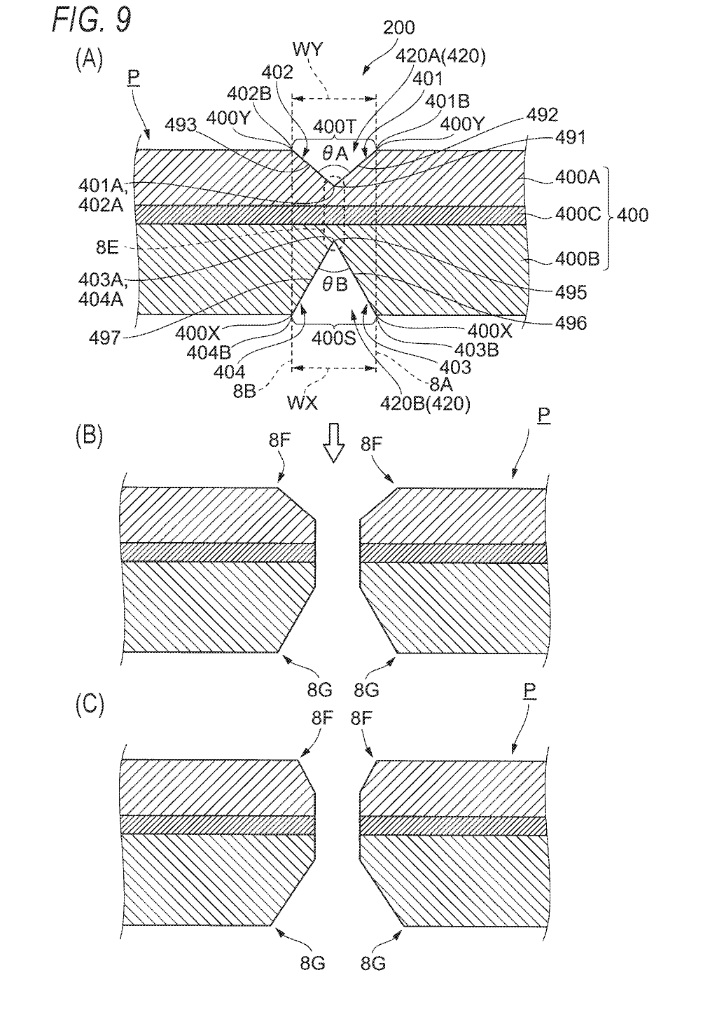

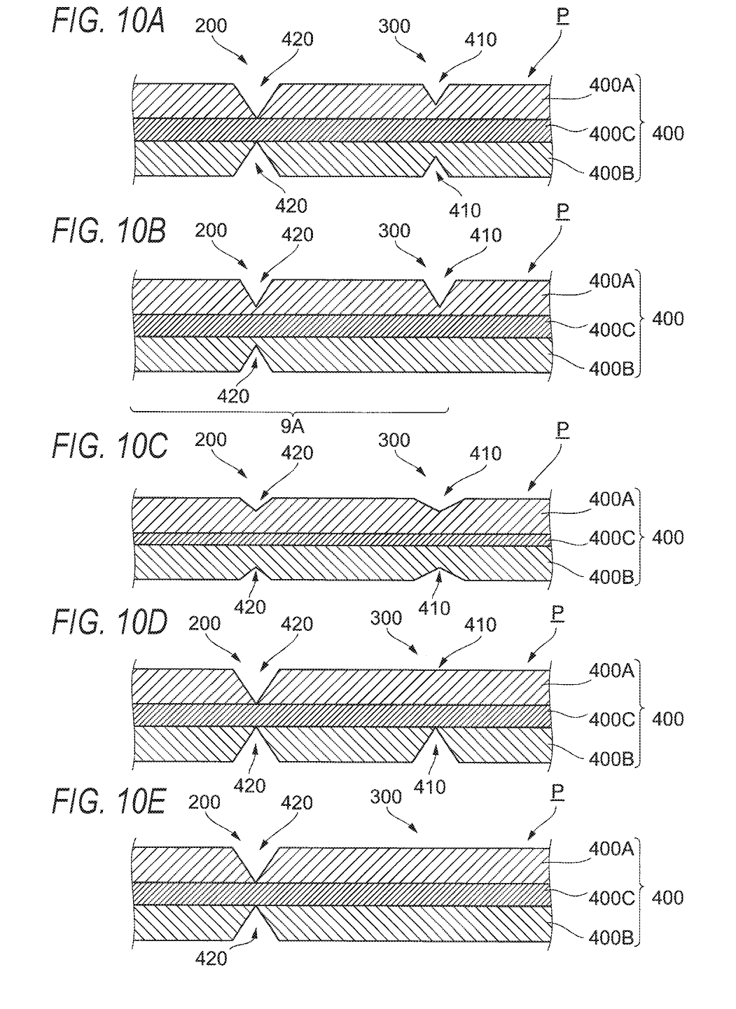

FIGS. 10A-10E show paper sheets P having other example configurations.

In the example configuration shown in FIG. 10A, in a bending portion 300, a bending cut 410 is formed in both of the front-side sheet 400A and the back-side sheet 400B. In other words, in both of the separating portion 200 and the bending portion 300, a cut (bending cut 410 or separating cut 420) is formed in both of the front-side sheet 400A and the back-side sheet 400B.

In this example configuration, the depth of the bending cuts 410 of the bending portion 300 is smaller than that of the separating cuts 420 of the separating portion 200, whereby the bending cuts 410 of the bending portion 300 are different in shape from the separating cuts 420 of the separating portion 200.

In the example configuration shown in FIG. 10A, as in the above-described example configurations, in the separating portion 200 the separating cut 420 is formed in both of the front-side sheet 400A and the back-side sheet 400B, whereby the paper sheet P can be divided easily.

Furthermore, in this example configuration, in the bending portion 300, the bending cut 410 is also formed in the front-side sheet 400A. This allows a user to recognize portions that should be subjected to bending.

Where bending cuts 410 are formed only in the back-side sheet 400B, since the bending cuts 410 are located inside when bending is performed, a user is hard to recognize the portions to be subjected to the bending. Forming bending cuts 410 also in the front-side sheet 400A allows a user to easily recognize the portions to be subjected to bending.

Where bending cuts 410 are formed also in the front-side sheet 400A in each bending portion 300, the substantial thickness of the paper sheet P excluding the bending cuts 410 is reduced in each bending portion 300 and hence each bending portion 300 may become weaker. In view of this, in the example configuration shown in FIG. 10A, the cutting length of the bending cut 410 is set short in both of the front-side sheet 400A and the back-side sheet 400B. As a result, a necessary substantial thickness of the paper sheet P is secured and hence each bending portion 300 is given necessary strength.

In the example configuration shown in FIG. 10B, separating cuts 420 of a separating portion 200 are arranged differently from a bending cut 410 of a bending portion 300. More specifically, whereas in the separating portion 200 the separating cut 420 is formed in both of the front-side sheet 400A and the back-side sheet 400B, in the bending portion 300 the bending cut 410 is formed only in the front-side sheet 400A.

In this example configuration, the paper sheet P is bent so that a portion 9A (see FIG. 10B) is moved upward. The bending can be performed easily because the bending cut 410 is formed in the front-side sheet 400A.

In the example configuration shown in FIG. 10C, in each of a separating portion 200 and a bending portion 300, cuts having the same depth are formed in the front-side sheet 400A and the back-side sheet 400B, respectively.

In this example configuration, to secure necessary strength of the bending portion 300, the bending cuts 410 of the bending portion 300 are shallower than the bending cut 410 shown in FIG. 2 etc. Likewise, the separating cuts 420 of the separating portion 200 are shallower than the separating cuts 420 shown in FIG. 2 etc.

In the example configuration shown in FIG. 10C, the separating cuts 420 of the separating portion 200 are different in shape from the bending cuts 410 of the bending portion 300. More specifically, the separating cuts 420 of the separating portion 200 have a triangular sectional shape that is long in the vertical direction in FIG. 10C and the bending cuts 410 of the bending portion 300 have a triangular sectional shape that is long in the horizontal direction.

In other words, the opening angle of the separating cuts 420 of the separating portion 200 is smaller than that of the bending cuts 410 of the bending portion 300. Furthermore, the width, in the surfaces of the paper sheet body 400, of the separating cuts 420 of the separating portion 200 is smaller than that of the bending cuts 410 of the bending portion 300.

In the example configuration shown in FIG. 10C, since the opening angle of the separating cuts 420 is small, stress is concentrated on a portion being divided more easily and hence the working load that is necessary for the dividing is made smaller than in a case that the opening angle of the separating cuts 420 are large.

In addition, since the opening angle of the separating cuts 420 is small, the angle formed by the end surface of a divided portion of the paper sheet P and the front surface or the back surface of the paper sheet P becomes close to the right angle.

In the example configuration shown in FIG. 10C, since the width (i.e., opening angle) of the bending cuts 410 of the bending portion 300 is large, as in the above-described example configurations, portions located on the two respective sides of each bending cut 410 are less prone to interfere with each other and hence the paper sheet P is easy to bend.

Furthermore, in this example configuration, since the front-side sheet 400A is also formed with a bending cut 410, a user can see a portion to be bent of the paper sheet P and hence can recognize that portion easily.

FIGS. 10D and 10E show a paper sheet P having another example configuration. FIG. 10D is a sectional view taken along line XD-XD in FIG. 6, and FIG. 10E is a sectional view taken along line XE-XE in FIG. 6.

In this example configuration, as shown in FIGS. 6, 10D, and 10E, the bending cut 410 of each bending portion 300 is formed like perforations. In other words, in each bending portion 300, cuts and non-cut portions 470 are arranged alternately along the bending portion 300.

On the other hand, in each separating portion 200, no non-cut portions 470 are formed and, as shown in FIGS. 6, 10D, and 10E, the separating cut 420 extends continuously along the separating portion 200.

Since the separating cut 420 extends continuously in each separating portion 200, the working load that is necessary for dividing the paper sheet P there can be made smaller than in a case that the separating cut 420 is formed like perforations.

Furthermore, since the bending cut 410 is formed like perforations, each bending portion 300 is stronger than in a case that the bending cut 410 extends continuously.

Although in the example configurations shown in FIGS. 10A-10E, the front-side sheet 400A and the back-side sheet 400B are the same in thickness, one of them may be made thinner than the other.

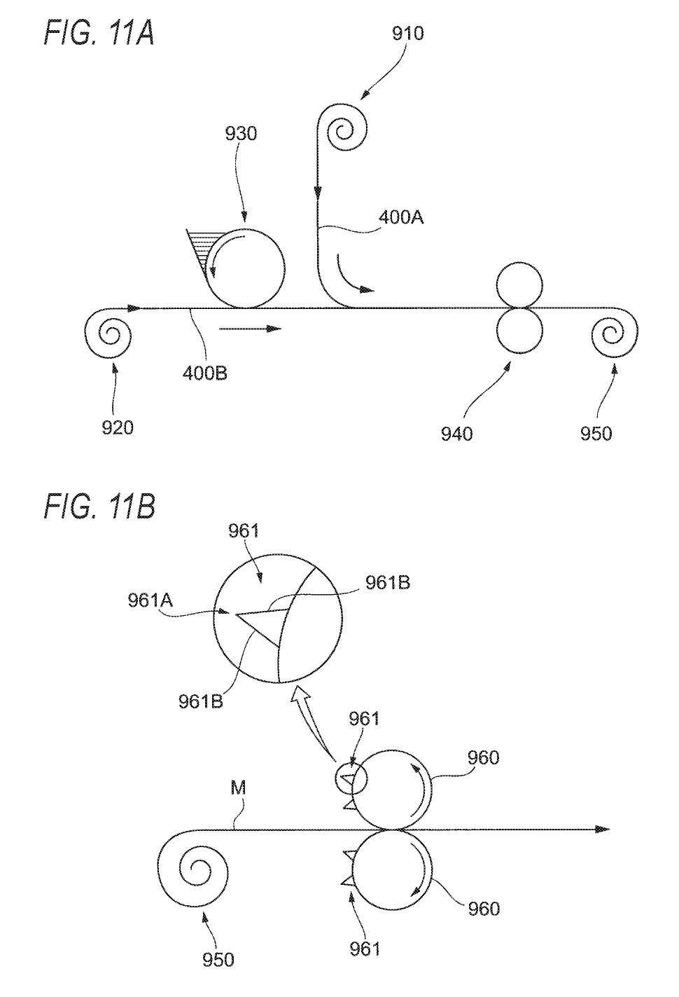

FIGS. 11A and 11B illustrate a manufacturing process of a paper sheet P.

FIG. 11A illustrates a manufacturing process of an original paper sheet of a paper sheet P. To manufacture an original paper sheet of a paper sheet P, part of a front-side sheet 400A is paid out downstream from a roll 910 of the front-side sheet 400A. And part of a back-side sheet 400B is paid out downstream from a roll 910 of the back-side sheet 400B. Furthermore, an adhesive such as a hot-melt adhesive is applied to one surface of the part, being paid out downstream, of the back-side sheet 400B using an applying device 930.

For example, the adhesive is applied by bringing a roll to whose outer circumferential surface the adhesive is stuck into contact with the back-side sheet 400B. Alternative processes are possible in which a powder-like adhesive is put on the back-side sheet 400B or an adhesive is stuck to the back-side sheet 400B using a spray device.

Then the front-side sheet 400A is put on the back-side sheet 400B.

Subsequently, the front-side sheet 400A and the back-side sheet 400B are heated and pressed against each other using pressing rolls 940 which are a pressing device. As a result, the front-side sheet 400A and the back-side sheet 400B are bonded to each other to become an original paper sheet of a paper sheet P. The original paper sheet is then taken up into a roll body 950.

FIG. 11B illustrates a manufacturing process for manufacturing a paper sheet P from the roll body 950.

To manufacture a paper sheet P, first, the roll body 950 is unwound and a resulting continuous original paper sheet M is sent downstream. Then rolls 960 to whose outer circumferential surfaces cutting blades 961 are attached are pressed against the two respective surfaces of the original paper sheet M.

As a result, above-described cuts (bending cuts 410 and separating cut 420) are formed in the original paper sheet M. Subsequently, the resulting original paper sheet M is cut by a cutting machine (not shown), whereby a rectangular paper sheet P (see FIG. 1) is completed.

The cutting blades 961 are triangular in cross section. By pressing apex portions 961A of the cutting blades 961 against the paper sheet P, the fiber of portions involved of the paper sheet P is cut. Furthermore, each of these portions of the paper sheet P is pushed aside (outward) by two side surfaces 961B of the cutting blade 961, whereby a cut having a triangular cross section as mentioned above is formed.

### Others

It is expected that the above-described paper sheet P will be set in an image forming apparatus and an image is formed thereon. Since the paper sheet P is subjected to various operations such as conveyance in the image forming apparatus, it is preferable that the paper sheet P be strong enough to withstand those various operations.

More specifically, for example, it is preferable that the paper sheet P be so strong as not to be divided at a bending portion 300 when conveyed in an image forming apparatus. To this end, it is preferable that the portion of each bending portion 300 including the bonding layer 400C and excluding the bending cut(s) 410 be so thick that the paper sheet P is not divided there.

Even more specifically, it is preferable that in a cross section of each bending portion 300 where a bending cut 410 is formed the portion 2Z (see FIG. 2) be so thick that the paper sheet P is not divided there.

From the viewpoint of improving the appearance of an image formed on the paper sheet P by an image forming apparatus, it is preferable not to form bending cuts 410 in the layer to be placed outside the bonding layer 400C by bending. More specifically, it is preferable that no bending cuts 410 be formed in the layer to be placed outside the bonding layer 400C by bending whereas it is allowed to form an image(s) on the layer to be placed outside by bending so as to cover the bending portions 300.

If bending cuts 410 were formed in the layer to be placed outside by bending, an image(s) formed on this layer (so as to cover the bending portions 300) might be divided by the bending cuts 410 to degrade the appearance of the image(s). In other words, if bending cuts 410 and an image(s) were formed in and on the layer to be placed outside by bending, innards of the paper sheet P are exposed by bending to make the image(s) discontinuous.

In contrast, the above-described measure of not forming bending cuts 410 in the layer to be placed outside the bonding layer 400C prevents division of an image(s) (i.e., it is kept continuous) and allows the image(s) to be kept good in appearance.

Where as in the exemplary embodiment bending cuts 410 are formed in the layer to be placed inside by bending, an image(s) can be formed more easily so as to cover bending portions 300 than in the case of forming scores.

In this connection, bending portions 300 are formed with scores in many cases and, in general, such scores are formed in the layer to be placed outside by bending. In this case, in many cases, it is difficult to form an image (s) on a paper sheet P that is formed with such scores. More specifically, in many cases, it is difficult to form an image on a portion that is formed with a score because that portion is undulated.

In contrast, where as in the exemplary embodiment bending cuts 410 are formed in the layer to be placed inside by bending, an image(s) can be formed more easily so as to cover bending portions 300 than in the case of forming scores.

In this connection, in printing etc., in general, by forming an image on a paper sheet P, then forming scores, and finally bending the paper sheet P, the image can be kept continuous though the scores are formed.

However, in a post-processing apparatus that is connected to an image forming apparatus (sores are formed by the post-processing apparatus), there may occur an event that it becomes difficult to form scores in a thick paper sheet or to form scores in a portion that has been increased in strength by an image (i.e., toner). In view of this, in image forming apparatus and post-processing apparatus, paper sheets to be used are restricted to thin ones, a control is performed so as not to form an image(s) in portions to be formed with scores, or an image(s) is formed so as not to cover portions that are formed with scores.

In contrast, where as in the exemplary embodiment bending cuts 410 are formed in the layer to be placed inside by bending, the above problems that are associated with the formation of scores do not arise.

Where bending cuts 410 are formed in the layer to be placed inside by bending, it is preferable that the bending cuts 410 be formed inward from the surface of the layer and be wider at the surface than inside.

In other words, to prevent an event that a portion, formed with an image, of a paper sheet P is separated from the paper sheet P by bending, it is preferable that bending cuts 410 be formed inward from the surface of the layer to be placed inside by bending and be wider at the surface than inside.

In this connection, when a paper sheet P is bent in which a line-shaped cut has been formed in the layer to be placed inside by bending, the outside layer is expanded more there to cause an event that a portion, formed with an image, of the outside layer goes off the paper sheet P. If the degree of expansion of the outside layer is too high, the outside layer of the paper sheet P may break partially to disorder the image formed on the paper sheet P.

In contrast, where bending cuts 410 are formed inward from the surface of the inside layer and are wider at the surface than inside, the degree of expansion of the outside layer caused by bending is lowered and hence an event that a portion, formed with an image, of the outside layer goes off the paper sheet P is less likely to occur.

The above-described exemplary embodiment can also be construed as follows:

A paper sheet comprising:
a paper sheet body; and
a cut that is formed in a portion, to be subjected to bending, of the paper sheet body on a side to be placed inside by bending so as to extend inward from a surface of the paper sheet body and to be wider at the surface of the paper sheet body than inside the paper sheet body.

The paper sheet wherein the cut becomes wider as the position goes from inside the paper sheet body to its surface, and the cut has an opening angle that is in a range of 40° to 100°.

The paper sheet wherein one surface of the paper sheet body is formed with another cut, and the other surface is formed with a cut extending alongside the other cut at a position that is on the back side of the other cut.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A sheet comprising:
a cut that is formed in a part, in a sheet thickness direction, of a bending portion, to be subjected to bending, of a sheet body; and
a bonding layer that lies between a layer that is formed with the cut in the bending portion and a layer that is not with the cut in the bending portion, in a sectional view taken perpendicularly to the surfaces of the sheet.

2. The sheet according to claim 1, wherein:
the sheet further comprises one side layer and other side layer that are located on the two respective sides of the bonding layer, the one side layer being to be placed inside the bonding layer by bending; and
the cut is formed in the one side layer.

3. The sheet according to claim 2, wherein the cut reaches a position close to the bonding layer in the sheet thickness direction.

4. The sheet according to claim 1, wherein the cut is formed so as to leave at least part of the bonding layer in the sheet thickness direction.

5. The sheet according to claim 1, wherein the cut consists of plural cuts.

6. The sheet according to claim 5, wherein the plural cuts are arranged along the bending portion and a non-cut portion exists between adjacent ones of the plural cuts.

7. The sheet according to claim 6, wherein the non-cut portion is 0.3 to 1.0 mm in length.

8. The sheet according to claim 5, wherein the plural cuts are plural sets of cuts, the plural sets being arranged along the bending portion and spaced from each other in a direction that is perpendicular to an extending direction of the plural cuts.

9. The sheet according to claim 2, wherein the other side layer is thinner than the one side layer.

10. The sheet according to claim 2, wherein the cut is formed so as to extend inward from the surface of the one side layer, increase in width as the position comes closer the surface of the one side layer, and have an opening angle that is in a range of 40° to 100°.

11. The sheet according to claim 2, wherein:
another cut is formed in the one side layer at a different position than the cut is formed;
a cut is formed in the other side layer alongside the other cut at such a position as to be opposed to the other cut with the bonding layer interposed in between.

12. The sheet according to claim 1, wherein:
the sheet is to be subjected to image formation by an image forming apparatus; and
the layer that is not formed with the cut plus the adhesive layer have such a thickness in the sheet thickness direction as to be so strong that the sheet is not divided at the being portion when the sheet is conveyed in the image forming apparatus.

13. The sheet according to claim 2, wherein:
the sheet is to be subjected to image formation by an image forming apparatus; and
no cut is formed in the other side layer at such a position as to be opposed to the cut formed in the one side layer so that an image can be formed on the other side layer so as to cover the bending portion.

14. The sheet according to claim 13, wherein the cut is formed in the one side layer in a direction going inward from the surface of the one side layer, and is wider at the surface than inside so that a portion, formed with an image, of the sheet will not be separated from the sheet by bending.

15. A sheet comprising:
a sheet body having a one side layer and other side layer that are located on the two respective sides of a bonding layer, the other side layer being thinner than the one side layer;
a first cut that is formed in the one side layer in such a manner as to be wider at the surface than inside in a thickness direction of the one side layer; and
a second cut that is formed in the other side layer in such a manner as to be wider at the surface than inside in a thickness direction of the other side layer and to have a larger opening angle and a smaller depth than the first cut, and that works together with the first cut to allow division of the sheet.

16. The sheet according to claim 15, wherein:
the first cut has an opening in the surface of the one side layer;
the second cut has an opening in the surface of the other side layer; and
opening edges of the second cut are opposed to respective opening edges of the first cut with the bonding layer located in between.

17. A sheet comprising:
a sheet body having a one side layer and other side layer that are located on the two respective sides of a bonding layer;
cuts that are formed in the one side layer and the other side layer, respectively, in and along a separating portion, to be subjected to dividing, of the sheet body; and
a cut that is formed in and along a bending portion, to be subjected to bending, of the sheet body, in a different manner of arrangement or shape than the cuts formed in the separating portion.

18. The sheet according to claim 17, wherein the cut formed in the bending portion is formed in one of the one side layer and the other side layer of the sheet body.

19. The sheet according to claim 1, further comprising:
cuts that are formed in the layer that is formed with the cut and the layer that is not with the cut, respectively, in and along a separating portion, to be subjected to dividing, of the sheet body,
wherein the cuts formed in the separating portion are different in width or depth from the cut formed in the bending portion.

20. The sheet according to claim 1, wherein one, to be placed outside by bending, of the layer that is formed with the cut and the layer that is not with the cut is thinner than the other.
